(19) United States
(12) Patent Application Publication
(10) Pub. No.: US 2006/0263531 A1
(43) Pub. Date: Nov. 23, 2006

(54) POLYHEDRAL OLIGOMERIC SILSESQUIOXANES AS GLASS FORMING COATINGS

(76) Inventors: Joseph D. Lichtenhan, Petal, MS (US); Xuan Fu, Purvis, MS (US); France Frechette, Quebec (CA); James W. Tatalick, Eastlake, OH (US)

Correspondence Address: PILLSBURY WINTHROP SHAW PITTMAN LLP, P.O. BOX 10500, MCLEAN, VA, 22102, US

(21) Appl. No.: 11/420,207

(22) Filed: May 24, 2006

Related U.S. Application Data
(63) Continuation-in-part of application No. 11/297,041, filed on Dec. 7, 2005.
(63) Continuation-in-part of application No. 11/015,185, filed on Dec. 17, 2004.
(60) Provisional application No. 60/684,415, filed on May 24, 2005.
(60) Provisional application No. 60/634,495, filed on Dec. 8, 2004.
(60) Provisional application No. 60/531,458, filed on Dec. 18, 2003.

(51) Int. Cl. B05D 3/02

(52) U.S. Cl. 427/377

(57) ABSTRACT

A method of using nanoscopic silicon containing agents for in situ formation of nanoscopic glass layers on material surfaces is described. Because of their tailorable compatibility with polymers, metals, composites, ceramics, glasses and biological materials, nanoscopic silicon containing agents can be readily and selectively incorporated into materials at the nanometer level by direct mixing processes. Improved properties include gas and liquid barrier; stain resistance; resistance to environmental degradation; adhesion; printability; time dependent mechanical and thermal properties such as heat distortion, creep, compression set, shrinkage, and modulus; hardness and abrasion resistance; oxidation resistance; electrical and thermal conductivity; and fire resistance.

### CROSS-REFERENCE TO RELATED APPLICATIONS

This application claims the benefit of U.S. Provisional Patent Application Ser. No. 60/684,415 filed May 24, 2005, and is a continuation-in-part of U.S. patent application Ser. No. 11/297,041 filed Dec. 7, 2005 (which claims the benefit of U.S. Provisional Application Ser. No. 60/634,495 filed Dec. 8, 2004), which is a continuation-in-part of U.S. patent application Ser. No. 11/015,185 filed Dec. 17, 2004 (which claims the benefit of 60/531,458 filed Dec. 18, 2003). The disclosures of the foregoing applications are incorporated herein by reference.

### FIELD OF THE INVENTION

This invention relates to methods for enhancing the properties of the thermoplastic and thermoset polymers and, more particularly, to the incorporation of nanostructured chemicals into such polymers for in situ glassification of polymer surfaces during exposure to chemical oxidizing agents such as ozone, peracetic acid, and hydrogen peroxide.

The applications for such materials include polymers for use in coatings, adhesives, molded articles, cast articles, single and multilayered material articles in medical and dental products such as surgical instruments, rigid and flexible endoscopes, passive and active implants, medical device accessories such as containers, trays and packaging of medical devices.

### BACKGROUND OF THE INVENTION

The invention is related to use of polyhedral oligomeric silsesquioxane, silsesquioxane, polyhedral oligomeric silicate, silicates, and silicones as alloyable agents within polymeric materials for the formation of a glassy surface upon exposure to ozone, oxygen, steam, or other oxidizing medium or chemical agents for medical application. Polyhedral oligomeric silsesquioxane, silsesquioxane, polyhedral oligomeric silicate, silicates, and silicones are hereafter referred to as “silicon containing agents.”

Silicon containing agents have previously been utilized for the dispersion and alloying of the silicon atoms with polymer chains uniformly at the nanoscopic level. As discussed in U.S. Pat. No. 6,767,930, silicon containing agents can be converted in the presence of atomic oxygen to form a glass like silica layer.

It is now surprisingly discovered that such silicon containing agents are also useful in the decontamination of polymers, as they are effective at forming a glassy layer that prevents both bacterial infusion through the glassy surface layer and prevents degradation of the polymer from subsequent exposures to oxidizing decontamination agents. In such capacity the silicon containing agents are themselves effective when alloyed into a polymer but are preferably utilized for the in situ formation of nanoscopically thin glass barriers upon their exposure to hot water, peroxide, oxygen plasma, ozone, organic acids, oxides or peroxides, or an oxidizing flame. Upon exposure to such oxidants, the silicon containing agents render surface glass layers including silica. Advantages of the method and nanoscopically thin glass layer include: undetectability by the human eye; toughness and flexibility, and thereby well suited for storage on rolls and molded packaging; impermeability to moisture and gas; direct printability; stain resistance; scratch resistance; lower cost and lighter weight than glass; and excellent adhesion between polymer and glass due to elimination of discreet compositional bondlines and replacement of them by compositionally graded material interfaces.

The use of silicon containing agents in polymers for protection against an oxidizing environment has been discussed in U.S. Pat. No. 6,767,930. However, the prior art does not consider the utility of such a material in decontamination coatings.

A number of prior art methods are known to produce glass coatings on polymers. These methods include elevated temperature sintering, sputtering, vapor deposition, sol-gel, and coating processes, which all require an additional manufacturing steps and are not amenable to high speed molding and extrusion processing. These prior art methods also suffer from poor interfacial bonding between the glass and polymer layers. The prior art also fails to incorporate metal and nonmetal atoms into a well defined nanoscopic structure within a single glass layer. Finally, the prior art is not able to produce nanoscopically thin glass surfaces, and consequently the methods are not amenable to the high speed manufacture of flexible packaging and especially repeated decontamination processing.

The silicon containing agents of most utility in this work are best exemplified by those based on low cost silicones such as silsesquioxanes, polyhedral oligomeric silsesquioxanes, and polyhedral oligomeric silicates. FIG. 1 illustrates some representative examples containing siloxane, silsesquioxane, and silicate. The R groups in such structures can range from H, to alkane, alkene, alkyne, aromatic and substituted organic systems including ethers, acids, amines, thiols, phosphates, and halogenated R groups.

The silicon containing agents all share a common hybrid (i.e. organic-inorganic) composition in which the internal framework is primarily comprised of inorganic silicon-oxygen bonds. Upon mild and further oxidation these systems readily form silica glasses. The exterior of a nanostructure is covered by both reactive and nonreactive organic functionalities (R), which ensure compatibility and tailorability of the nanostructure with organic polymers. These and other properties of nanostructured chemicals are discussed in detail in U.S. Pat. Nos. 5,412,053 and 5,484,867, which are incorporated herein by reference. These nanostructured chemicals are of low density, and can range in diameter from 0.5 nm to 5.0 nm.

### SUMMARY OF THE INVENTION

The present invention describes a new series of polymer additives and their utility in the in situ formation of nanoscopic glass layers on polymer surfaces. The resulting nano-alloyed polymers are useful by themselves or in combination with other polymers, or in combination with macroscopic reinforcements such as fiber, clay, glass, metal, mineral, and other particulate fillers. The nano-alloyed polymers are particularly useful for producing polymeric medical equipment and devices with inherent resistance to degradation by repeated exposure to ozone and other oxidizing decontamination processes such as hydrogen peroxide, peracetic acid, etc.

The preferred compositions presented herein contain two primary material combinations: (1) silicon containing agents including nanostructured chemicals, nanostructured oligomeric, or nanostructured polymers from the chemical classes of silicones, polyhedral oligomeric silsesquioxanes, polysilsesquioxanes, polyhedral oligomeric silicates, polysilicates, polyoxometallates, carboranes, and boranes; and (2) manmade polymer systems such as polystyrene, polyamides, polyolefins, polyurethanes, polyesters, polycarbonates, polyethers, epoxy, cyanate esters, maleimides, phenolics, polyimides, fluoropolymers, rubber, and natural polymers including cellulosics, sugars, starches, proteins, chitins, and all semicrystalline, crystalline, glassy, elastomeric polymers, and copolymers thereof.

The method of incorporating nanostructured chemicals into thermoplastics is preferably accomplished via melt mixing of the silicon containing agents into the polymers. The incorporation of the silicon containing agents into thermosets can be accomplished through melt blending, milling or solvent assisted methods. All types and techniques of blending, including melt blending, dry blending, solution blending, reactive and nonreactive blending are effective.

In addition, the selective incorporation and maximum loading levels of a silicon containing agent into a specific polymer can be accomplished through use of a silicon containing agent with a chemical potential (miscibility) compatible with the chemical potential of the region within the polymer in which it is to be alloyed. Because of their chemical nature, silicon containing agents can be tailored to show compatibility or incompatibility with selected sequences and segments within polymer chains and coils. Their physical size in combination with their tailorable compatibility enables silicon containing agents based on nanostructured chemicals to be selectively incorporated into polymers and to control the dynamics of coils, blocks, domains, and segments, and subsequently favorably impact a multitude of physical properties.

The process of forming in situ glass glazings on articles molded from polymers alloyed with silicon containing agents is carried out by exposure of the articles to oxygen plasma, ozone, or other oxidizing mediums. These chemical oxidation methods are desirable as they inactivate microorganisms, they are current medical processes, and they do not result in heating of the polymer surface. There are no topological constraints on the molded articles. Both thin films and thick parts derived from the alloyed polymers can be processed to contain nanometer thick surface glass layers. The most efficient and thereby preferred oxidation methods are steam, peroxide, oxygen plasma, and ozone. For alloys where the R on the silicon containing agent is H, methyl or vinyl, they can in general be converted to glass upon exposure to ozone, peroxide, or hot steam. A reliable alternate to the above methods is the use of an oxidizing flame. The choice of method is dependent upon the chemical agent-polymer alloy system, loading level of the silicon containing chemical agent, surface segregation of agent, the thickness of the silica surface desired and manufacturing considerations. A schematic view of the process is shown in FIG. 2.

Upon exposure of the surface to the oxidation source, a nanoscopically thin layer of glass from 1 nm-500 nm, preferably 1 nm-50 nm, and most preferably 1 nm-30 nm, will result. If the silica containing agent contains a metal, then the metal will also be incorporated into the glass layer. Advantages derived from the formation of a nanoscopic glass surface layer include barrier properties for gases and liquids, improved oxidative stability, flammability reduction, improved electrical properties, improved printability, and improved stain and scratch resistance

### BRIEF DESCRIPTION OF THE DRAWINGS

FIG. 1 shows representative structural examples of nonmetallized silicon containing agents.

FIG. 2 illustrates the chemical process of oxidative conversion of the silicon agents into a fused nanoscopically thin glass layer.

FIG. 3 illustrates the ability to form a nanoscopically thin barrier layers inside and outside a molded plastic article.

FIG. 4 illustrates a rough silicon containing agent alloyed polymer surface and a decrease in surface roughness after the in situ formation of a nanoscopic glass layer.

### DEFINITION OF FORMULA REPRESENTATIONS FOR NANOSTRUCTURES

For the purposes of understanding this invention's chemical compositions the following definition for formula representations of silicon containing agents and in particular Polyhedral Oligomeric Silsesquioxane (POSS) and Polyhedral Oligomeric Silicate (POS) nanostructures is made.

Polysilsesquioxanes are materials represented by the formula [RSiO_{1.5}]_{∞} where ∞ represents molar degree of polymerization and R=represents an organic substituent (H, siloxy, cyclic or linear aliphatic or aromatic groups that may additionally contain reactive functionalities such as alcohols, esters, amines, ketones, olefins, ethers or which may contain halogens). Polysilsesquioxanes may be either homoleptic or heteroleptic. Homoleptic systems contain only one type of R group while heteroleptic systems contain more than one type of R group.

A subset of silicon containing agents are classified as POSS and POS nanostructure compositions are represented by the formula:
[(RSiO_{1.5})ₙ]_{Σ#} for homoleptic compositions
[(RSiO_{1.5})n(R′SiO_{1.5})m]_{Σ#}for heteroleptic compositions (where R≠R′)
[(RSiO_{1.5})n(RXSiO_{1.0})m]_{Σ#} for functionalized heteroleptic compositions (where R groups can be equivalent or inequivalent)
   In all of the above R is the same as defined above and X includes but is not limited to OH, Cl, Br, I, alkoxide (OR), acetate (OOCR), peroxide (OOR), amine (NR₂) isocyanate (NCO), and R. The symbols m, n and j refer to the stoichiometry of the composition. The symbol Σ indicates that the composition forms a nanostructure and the symbol # refers to the number of silicon atoms contained within the nanostructure. The value for # is usually the sum of m+n, where n ranges typically from 1 to 24 and m ranges typically from 1 to 12. It should be noted that Σ# is not to be confused as a multiplier for determining stoichiometry, as it merely describes the overall nanostructural characteristics of the system (aka cage size).

### DETAILED DESCRIPTION OF THE INVENTION

The present invention teaches the use of silicon containing agents as alloying agents for the absorption of radiation and for the in situ formation of glass layers in polymeric materials and for the reinforcement of polymer coils, domains, chains, and segments at the molecular level.

The keys that enable silicon containing agents such as nanostructured chemicals to function in this capacity include: (1) their unique size with respect to polymer chain dimensions, (2) their ability to be compatibilized and uniformly dispersed at the nanoscopic level with polymer systems to overcome repulsive forces that promote incompatibility and expulsion of the nanoreinforcing agent by the polymer chains, (3) the hybrid composition and its ability glassify upon exposure to selective oxidants, and (4) the ability to chemically incorporate metals into the silicon containing agent and into the corresponding glass rendered therefrom. The factors to effect selection of a silicon containing agent include the loading level of the silicon containing agent, and the optical, electronic, and physical properties of the polymers. The factors to effect selection of a silicon containing agent for permeability control and glassification include the nanosizes of nanostructured chemicals, distributions of nanosizes, and compatibilities and disparities between the nanostructured chemical and the polymer system, the loading level of the silicon containing agent, the thickness of the silicon layer desired and the optical, electronic, and physical properties of the polymer.

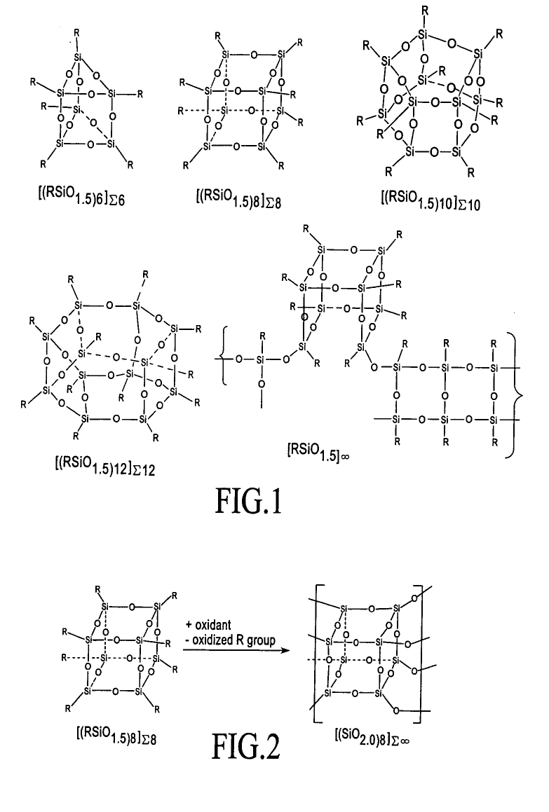

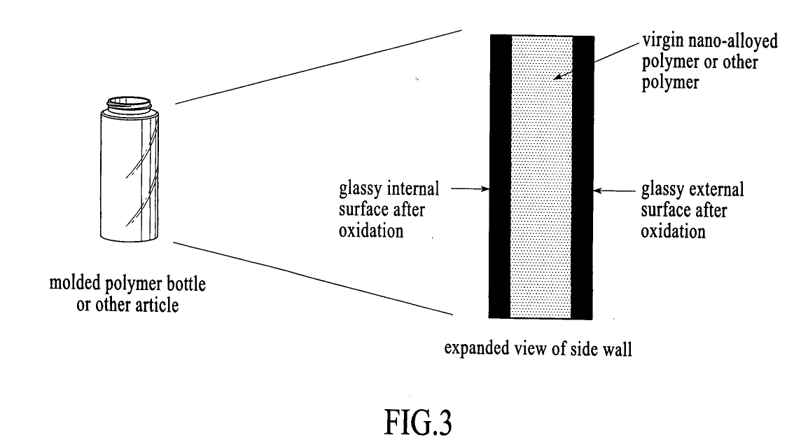

Silicon containing agents, such as the polyhedral oligomeric silsesquioxanes (POSS) illustrated in FIG. 1, are available as solids and oils and with or without metals. Both forms dissolve in molten polymers or in solvents, or can be reacted directly into polymers or can themselves be utilized as a binder material. For POSS, dispersion appears to be thermodynamically governed by the free energy of mixing equation (ΔG=ΔH−TΔS). The nature of the R group and ability of the reactive groups on the POSS cage to react or interact with polymers and surfaces greatly contributes to a favorable enthalpic (ΔH) term while the entropic term (ΔS) is highly favorable because of the monoscopic cage size and distribution of 1.0.

The above thermodynamic forces driving dispersion are also contributed to by kinetic mixing forces such as occur during high shear mixing, solvent blending or alloying. The kinetic dispersion is also aided by the ability of some silicon containing agents to melt at or near the processing temperatures of most polymers.

By controlling the chemical and processing parameters, nanoreinforcement and the alloying of polymers at the 1.5 nm level can be achieved for virtually any polymer system. Silicon containing agents can also be utilized in combination with macroscopic fillers to render similar desirable benefits relative to enhancements of physical properties, barrier, stain resistance and oxidation resistance.

The present invention demonstrates that property enhancements can be realized by the direct blending of silicon containing agents and preferably nanostructured chemicals into polymers. This greatly simplifies the prior art processes.

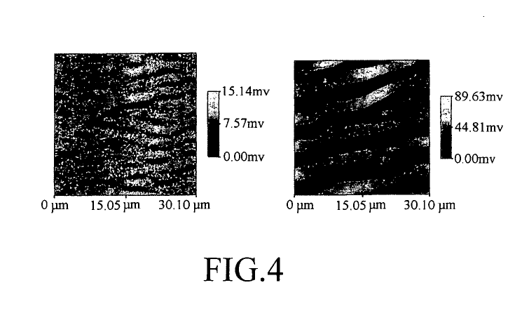

Furthermore, because silicon containing agents like nanostructured chemicals possess spherical shapes (per single crystal X-ray diffraction studies), like molecular spheres, and because they dissolve, they are also effective at reducing the viscosity of polymer systems. This benefits the processing, molding, or coating of articles using such nano-alloyed polymers, yet with the added benefits of reinforcement of the individual polymer chains due to the nanoscopic nature of the chemicals. Subsequent exposure of the nano-alloyed polymers to oxidizing agents results in the in situ formation of nanoscopic glass on the exposed surfaces. FIG. 2 illustrates the oxidation of silicones such as silsesquioxanes to glass. Upon exposure of the nano-alloyed polymer to an oxidizing source the silicon—R bonds are broken and the R group is lost as a volatile reaction byproduct while the valency to the silicon is maintained through the fusing of cages together by bridging oxygen atoms thus rendering the equivalent of fused glass. Thus, ease of in situ formation of this glass surface layer is obtainable through the use of nanostructured silicon containing agents, where the prior art would have required the use a secondary coating or deposition method that would have resulted in formation of a micron thick layer of glass on the surface. The nanoscopically dispersed nature of the silicon containing agent within and throughout the polymer affords the formation of the glass layer on the inside and outside of molded articles. FIG. 4 illustrates a rough silicon containing agent alloyed polymer surface and a decrease in surface roughness after the in situ formation of a nanoscopic glass layer. This is of tremendous advantage for articles such as bottles as it allows for in situ formed glass barrier inside and out while the oxidizing source also provides for sterilization. Such glass layers are also advantageous as they provide a more desirable surface for printing product information directly on the package. Additional benefit from the use of such nano-alloyed polymers is the ability of such materials to self-heal in the event of a loss of the surface glass layer. In such an event, the nanoscopic silica agents present underneath the original glass surface would then be available to undergo in situ conversion to a new and healing glass surface layer upon exposure to the oxidant. Such control over compatibility, dispersability, size, and manufacturability is unprecedented for all traditional fillers and coating technologies. Loading levels of the silica containing agent can range from 1-99 wt % with a preferred range from 1-30 wt %.

### EXAMPLES

General Process Variables Applicable to All Processes

As is typical with chemical processes there are a number of variables that can be used to control the purity, selectivity, rate and mechanism of any process. Variables influencing the process for the incorporation of silicon containing agents (e.g. Silicones and silsesquioxanes) into plastics include the size and polydispersity, and composition of the nanoscopic agent. Similarly the molecular weight, polydispersity and composition of the polymer system must also be matched between that of the silica agent and polymer. Finally, the kinetics, thermodynamics, processing aids, and filters used during the compounding or mixing process are also tools of the trade that can impact the loading level and degree of enhancement resulting from incorporation. Blending processes such as melt blending, dry blending and solution mixing blending are all effective at mixing and alloying nanoscopic silicon containing agents into plastics.

Alternate Method: Solvent Assisted Formulation. Silicon containing agents can be added to a vessel containing the desired polymer, prepolymer or monomers and dissolved in a sufficient amount of an organic solvent (e.g. hexane, toluene, dichloromethane, etc.) or fluorinated solvent to effect the formation of one homogeneous phase The mixture is then stirred under high shear at sufficient temperature to ensure adequate mixing for 30 minutes and the volatile solvent is then removed and recovered under vacuum or using a similar type of process including distillation. Note that supercritical fluids such as CO₂ can also be utilized as a replacement for the flammable hydrocarbon solvents. The resulting formulation may then be used directly or for subsequent processing.

### Example 1

### Oxidation Stability

The examples provided below shall not be construed as limiting toward specific material combinations or conditions.

Typical oxygen plasma treatments range from 1 seconds to 5 minutes under 100% power. Typical ozonolysis treatments range from 1 second to 5 minutes with ozone being administered through a CH₂Cl₂ solution with 0.03 equivalents O₃ per vinyl group. Typical steam treatments range from 1 second to 5 minutes. Typical oxidizing flame treatments range from 1 second to 5 minutes.

### Example 2

### Process Compatibility

Process compatibility testing was conducted on several POSS loaded epoxy adhesives when submitted to multiple cycles in an ozone sterilizer. The major advantage observed through in situ formation of glass on surface is an increase in the number to times a molded article could be re-used and re-decontaminated. Bulk resistance of two different formulation of POSS loaded epoxies are compared to two commercially available epoxy adhesives where weight changes are plotted against the number of ozone sterilization cycles. See Table 1. The samples have been cleaned periodically.

[image]

While certain representative embodiments and details have been shown for purposes of illustrating the invention, it will be apparent to those skilled in the art that various changes in the methods and apparatus disclosed herein may be made without departing from the scope of the invention which is defined in the appended claims.

What is claimed is:

1. A method for in situ formation of a glass layer on a polymer surface comprising the steps of:
(a) incorporating a silicon containing agent into a polymer; and
(b) oxidizing the surface to form a glass layer having a thickness between 1 nm and 500 nm.

2. The method of claim 1, wherein a mixture of different silicon containing agents is incorporated into the polymer.

3. The method of claim 1, wherein the polymer is in a physical state selected from the group consisting of oils, amorphous, semicrystalline, crystalline, elastomeric, and rubber.

4. The method of claim 1, wherein the polymer is a polymer coil, a polymer domain, a polymer chain, a polymer segment, or mixtures thereof.

5. The method of claim 1, wherein the silicon containing agent reinforces the polymer at a molecular level.

6. The method of claim 1, wherein the incorporation is nonreactive.

7. The method of claim 1, whereby the incorporation is reactive.

8. The method of claim 1, wherein a physical property of the polymer is improved as a result of incorporating the silicon containing agent into the polymer.

9. The method of claim 1, wherein the glass layer is formed using an oxidizing decontamination process selected from the group consisting of exposure to ozone, hydrogen peroxide, peracetic acid and hot steam.

10. The method of claim 8, wherein the physical property is selected from the group consisting of heat distortion, compression set, creep, adhesion, water repellency, fire retardancy, density, low dielectric constant, thermal conductivity, glass transition, viscosity, melt transition, storage modulus, relaxation, stress transfer, abrasion resistance, oxidation resistance, fire resistance, biological compatibility, gas permeability, porosity, and optical quality.

11. The method of claim 9, wherein the physical property is selected from the group consisting of heat distortion, compression set, creep, adhesion, water repellency, fire retardancy, density, low dielectric constant, thermal conductivity, glass transition, viscosity, melt transition, storage modulus, relaxation, stress transfer, abrasion resistance, fire resistance, biological compatibility, gas permeability, porosity, and optical quality.

12. The method of claim 8, wherein the incorporation is accomplished in combination with macroscopic and other nanoscopic fillers and additives.

13. The method of claim 9, wherein the incorporation and formulation step is accomplished in combination with macroscopic and other nanoscopic fillers and additives.

14. The method of claim 9, wherein the silicon containing agents are utilized with microscopic fillers to enhance physical properties, barriers, stain and oxidation resistance.

15. The method of claim 9, wherein the polymer has the ability to self-heal or to self-passivate upon loss of the surface glass layer.

16. The method of claim 9, wherein the silicon containing agent is reacted with material fillers or base structures.
